(19) United States
(12) Patent Application Publication
(10) Pub. No.: US 2024/0018364 A1
(43) Pub. Date: Jan. 18, 2024

(54) COMPOSITE FILM WITH ANTI-REFLECTIVE COATING

(71) Applicant: SAINT-GOBAIN PERFORMANCE PLASTICS CORPORATION, Solon, OH (US)

(72) Inventor: Yongzhong WANG, Tucson, AZ (US)

(21) Appl. No.: 18/256,254

(22) PCT Filed: Dec. 3, 2021
(86) PCT No.: PCT/US2021/072718

§ 371 Date: Jun. 7, 2023

Related U.S. Application Data
(60) Provisional application No. 63/122,995, filed on Dec. 9, 2020.

(51) Int. Cl. C09D 5/00; C09D 7/61; C09D 7/40; C08J 7/04

(52) U.S. Cl. CPC C09D 5/006; C09D 7/61; C09D 7/68; C09D 7/70; C08J 7/04

(57) ABSTRACT

A composite film may include a first transparent substrate and a first anti-reflective coating overlying a first surface of the first transparent substrate. The first anti-reflective coating may include a first binder component and a first particulate filler component. The first particulate filler component may include hollow silica nanoparticles. The composite film may further have a VLT of at least about 94.0% and a water contact angle of at least about 70°.

### TECHNICAL FIELD

The present disclosure relates to a composite film. In particular, the present disclosure relates to a composite film having an anti-reflective coating with particular solar energy and optical characteristics.

### BACKGROUND ART

Composite films can be used as coverings applied to various glass components to strength the glass and to control the passage of solar radiation through transmission, reflection, and absorption. For certain composite film applications, such as, for example, applications on or coverings of medical glass components including medical hoods, protective shields and protective glasses, the composite films must exhibit high visible light transmittance (“VLT”), a low haze value and a low reflectance. This combination of features is of great importance for particular systems. As such, a continuing need exists for improved composite films to use in such applications.

### SUMMARY

According to a first aspect, a composite film may include a first transparent substrate and a first anti-reflective coating overlying a first surface of the first transparent substrate. The first anti-reflective coating may include a first binder component and a first particulate filler component. The first particulate filler component may include hollow silica nanoparticles. The composite film may further have a VLT of at least about 94.0% and a water contact angle of at least about 70°.

According to yet another aspect, a composite film may include a first transparent substrate and a first anti-reflective coating overlying a first surface of the first transparent substrate. The first anti-reflective coating may include a first binder component and a first particulate filler component. The first particulate filler component may include hollow silica nanoparticles. The composite film may further have a VLT of at least about 94.0% and a water contact angle of at least about 80°.

### BRIEF DESCRIPTION OF THE DRAWINGS

Embodiments are illustrated by way of example and are not limited to the accompanying figures.

FIG. 1 includes an illustration of an example composite film according to certain embodiments described herein;

FIG. 2 includes an illustration of another example composite film according to certain embodiments described herein;

FIG. 3 includes an illustration of another example composite film according to certain embodiments described herein

FIG. 4 includes an illustration of another example composite film according to certain embodiments described herein;

FIG. 5a includes an illustration of another example composite film according to certain embodiments described herein;

FIG. 5b includes an illustration of another example composite film according to certain embodiments described herein;

FIG. 6a includes an illustration of another example composite film according to certain embodiments described herein; and

FIG. 6b includes an illustration of another example composite film according to certain embodiments described herein.

Skilled artisans appreciate that elements in the figures are illustrated for simplicity and clarity and have not necessarily been drawn to scale.

### DETAILED DESCRIPTION OF THE PREFERRED EMBODIMENT(S)

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

As used herein, the term “visible light transmittance” or “VLT” refers to the ratio of total light visible to the human eye (i.e., having a wavelength between 380 nm and 780 nanometers) that is transmitted through a composite stack/transparent substrate system and may be measured according to T-H ASTM C method by using a Haze Gard instrument from BYK.

As used herein, the term “haze value” refers to the percentage of light transmitted through a composite film that is deflected more than 2.5° from the direction of the incoming beam and may be measured according to T-H ASTM-C method using a Haze Gard instrument from BYK.

As used herein, the term “reflectance” refers to a measure of visible light that is reflected from a composite film surface when illuminated by a light source and may be measured according to ASTM E-1349 by using a HunterLab instrument.

Embodiments described herein are generally directed to composite films that include a first transparent substrate and a first anti-reflective coating. The anti-reflective coating may include a first binder component and a first particulate filler component. The first particulate filler component may include hollow-silica nanoparticles. The composite film formed according to embodiments described herein may have particular characteristics, such as, a high VLT and a low haze.

These concepts are better understood in view of the embodiments described below that illustrate and do not limit the scope of the present disclosure.

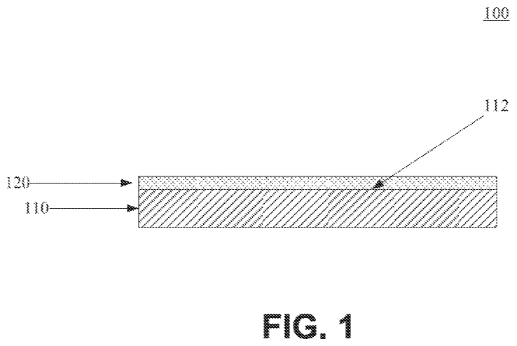

FIG. 1 includes an illustration of a cross-sectional view of a portion of an example composite film 100 according to embodiments described herein. As shown in FIG. 1, the composite film 100 may include a first transparent substrate 110 and a first anti-reflective coating 120 overlying a first surface 112 of the first transparent substrate 110.

According to certain embodiments, the composite film 100 may have a particular VLT. For example, the composite film 100 may have VLT of at least about 94.0%, such as, at least about 94.5% or at least about 95.5% or at least about 96.0% or at least about 96.5% or at least about 97.0% or at least about 97.5% or at least about 98.0% or at least about 98.5% or even at least about 99%. According to yet other embodiments, the composite film 100 may have a VLT of not greater than about 99.9%, such as, not greater than about 99.8% or even not greater than about 99.7%. It will be appreciated that the composite film 100 may have a VLT within a range between any of the minimum and maximum values noted above. It will be further appreciated that the composite film 100 may have a VLT of any value between any of the minimum and maximum values noted above.

According to still other embodiments, the composite film 100 may have a particular haze. For example, the composite film 100 may have a haze of at least about 0.5%, such as, at least about 0.6% or at least about 0.7% or even at least about 0.8%. According to still other embodiments, the composite film 100 may have a haze of not greater than about 2.0%, such as, not greater than about 1.9% or not greater than about 1.8% or not greater than about 1.7% or not greater than about 1.6% or even not greater than about 1.5%. It will be appreciated that the composite film 100 may have a haze within a range between any of the minimum and maximum values noted above. It will be further appreciated that the composite film 100 may have a haze of any value between any of the minimum and maximum values noted above.

According to yet other embodiments, the composite film 100 may have a particular reflectance. For example, the composite film 100 may have a reflectance of at least about 1.5% as measured at 550 nm, such as, at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or even at least about 3.5%. According to still other embodiments, the composite film 100 may have a reflectance of not greater than about 7.0% as measured at 550 nm, such as, not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or even not greater than about 5.0%. It will be appreciated that the composite film 100 may have a reflectance within a range between any of the minimum and maximum values noted above. It will be further appreciated that the composite film 100 may have a reflectance of any value between any of the minimum and maximum values noted above.

According to yet other embodiments the first anti-reflective coating 120 may have a particular first binder component concentration. For example, the first anti-reflective coating 120 may have a first binder component concentration of at least about 30 wt. % for a total weight of the first anti-reflective coating, such as, at least about 31.0 wt. % or at least about 32.0 wt. % or at least about 33.0 wt. % or at least about 34.0 wt. % or at least about 35.0 wt. % or at least about 36.0 wt. % or at least about 37.0 wt. % or at least about 38.0 wt. % or at least about 39.0 wt. % or at least about 40.0 wt. % or at least about 41.0 wt. % or at least about 42.0 wt. % or at least about 43.0 wt. % or even at least about 44.0 wt. %. According to still other embodiments, the first anti-reflective coating 120 may have a first binder component concentration of not greater than about 60 wt. % for a total weight of the first anti-reflective coating, such as, not greater than about 59 wt. % or not greater than about 58.0 wt. % or not greater than about 57.0 wt. % or not greater than about 56.0 wt. % or not greater than about wt. % or not greater than about 54.0 wt. % or not greater than about 53.0 wt. % or not greater than about 52.0 wt. % or not greater than about 51.0 wt. % or not greater than about wt. % or not greater than about 49.0 wt. % or even not greater than about 48.0 wt. %. It will be appreciated that the first anti-reflective coating 120 may have a first binder component concentration within a range between any of the minimum and maximum values noted above. It will be further appreciated that the first anti-reflective coating 120 may have a first binder component concentration of any value between any of the minimum and maximum values noted above.

According to particular embodiments, the first binder component may include particular materials. For example, the first binder component may include a UV curable binder. According to still other embodiments, the first binder component may include a UV curable acrylate, such as urethane acrylate, epoxy acrylate, polyester acrylate, silicone acrylate and fluorinated acrylate.

According to still other embodiments, the first binder component may include other particular materials. For example, the first binder component may include a curable polymeric binder. According to certain embodiments, the first binder component may include an acrylic binder, a polyester binder, epoxy binder.

According to yet other embodiments the first anti-reflective coating 120 may have a particular first particulate filler component concentration. For example, the first anti-reflective coating 120 may have a first particulate filler component concentration of at least about 40 wt. % for a total weight of the first anti-reflective coating, such as, at least about 41.0 wt. % or at least about 42.0 wt. % or at least about 43.0 wt. % or at least about 44.0 wt. % or at least about 45.0 wt. % or at least about 46.0 wt. % or at least about 47.0 wt. % or at least about 48.0 wt. % or at least about 49.0 wt. % or at least about 50.0 wt. % or at least about 51.0 wt. % or at least about 52.0 wt. % or at least about 53.0 wt. % or even at least about 54.0 wt. %. According to still other embodiments, the first anti-reflective coating 120 may have a first particulate filler component concentration of not greater than about 70 wt. % for a total weight of the first anti-reflective coating, such as, not greater than about 69 wt. % or not greater than about 68.0 wt. % or not greater than about 67.0 wt. % or not greater than about 66.0 wt. % or not greater than about 65.0 wt. % or not greater than about 64.0 wt. % or not greater than about 63.0 wt. % or not greater than about 62.0 wt. % or not greater than about 61.0 wt. % or not greater than about 60.0 wt. % or not greater than about 59.0 wt. % or even not greater than about 58.0 wt. %. It will be appreciated that the first anti-reflective coating 120 may have a first particulate filler component concentration within a range between any of the minimum and maximum values noted above. It will be further appreciated that the first anti-reflective coating 120 may have a first particulate filler component concentration of any value between any of the minimum and maximum values noted above.

According to yet other embodiments, the first particulate filler component may have a particular average particle size as measured by using a Microtrac particle analyzer. For example, the first particulate filler component may have an average particle size of at least about 120 nm, such as, at least about 125 nm or at least about 130 nm or at least about 135 nm or at least about 140 nm or at least about 145 nm or at least about 150 nm or at least about 155 nm or even at least about 160 nm. According to yet other embodiments, the first particulate filler component may have an average particle size of not greater than about 200 nm, such as, not greater than about 195 nm or not greater than about 190 nm or not greater than about 185 or not greater than about 180 nm or not greater than about 175 nm or even not greater than about 170 nm. It will be appreciated that the average particle size of the first particulate filler component may be within a range between any of the minimum and maximum values noted above. It will be further appreciated that the average particle size of the first particulate filler component may be any value between any of the minimum and maximum values noted above.

According to particular embodiments the first filler component may include hollow silica nanoparticles. According to other embodiments, the hollow silica nanoparticles may be spherical nanoparticles.

According to yet other embodiments, the hollow silica nanoparticles may have a particular average particle size as measured according to by using a Microtrac particle analyzer. For example, the hollow silica nanoparticles may have an average particle size of at least about 120 nm, such as, at least about 125 nm or at least about 130 nm or at least about 135 nm or at least about 140 nm or at least about 145 nm or at least about 150 nm or at least about 155 nm or even at least about 160 nm. According to yet other embodiments, the hollow silica nanoparticles may have an average particle size of not greater than about 200 nm, such as, not greater than about 195 nm or not greater than about 190 nm or not greater than about 185 or not greater than about 180 nm or not greater than about 175 nm or even not greater than about 170 nm. It will be appreciated that the average particle size of the hollow silica nanoparticles may be within a range between any of the minimum and maximum values noted above. It will be further appreciated that the average particle size of the hollow silica nanoparticles may be any value between any of the minimum and maximum values noted above.

According to other embodiments the first anti-reflective coating 120 may have a particular hollow silica nanoparticle concentration. For example, the first anti-reflective coating 120 may have a hollow silica nanoparticle concentration of at least about 40 wt. % for a total weight of the first anti-reflective coating, such as, at least about 41.0 wt. % or at least about 42.0 wt. % or at least about 43.0 wt. % or at least about 44.0 wt. % or at least about 45.0 wt. % or at least about 46.0 wt. % or at least about 47.0 wt. % or at least about 48.0 wt. % or at least about 49.0 wt. % or at least about 50.0 wt. % or at least about 51.0 wt. % or at least about 52.0 wt. % or at least about 53.0 wt. % or even at least about 54.0 wt. %. According to still other embodiments, the first anti-reflective coating 120 may have a hollow silica nanoparticle concentration of not greater than about 70 wt. % for a total weight of the first anti-reflective coating, such as, not greater than about 69 wt. % or not greater than about 68.0 wt. % or not greater than about 67.0 wt. % or not greater than about 66.0 wt. % or not greater than about wt. % or not greater than about 64.0 wt. % or not greater than about 63.0 wt. % or not greater than about 62.0 wt. % or not greater than about 61.0 wt. % or not greater than about 60.0 wt. % or not greater than about 59.0 wt. % or even not greater than about 58.0 wt. %. It will be appreciated that the first anti-reflective coating 120 may have a hollow silica nanoparticle concentration within a range between any of the minimum and maximum values noted above. It will be further appreciated that the first anti-reflective coating 120 may have a hollow silica nanoparticle concentration of any value between any of the minimum and maximum values noted above.

According to other embodiments, the first anti-reflective coating 120 may further include a first anti-smudge additive.

According to particular embodiments, the first anti-smudge additive may include silicone acrylate, a fluoro acrylate, or a fluorinated poly(meth)acrylate.

According to yet other embodiments the first anti-reflective coating 120 may have a particular first anti-smudge additive concentration. For example, the first anti-reflective coating 120 may have a first anti-smudge additive concentration of at least about 10 wt. % for a total weight of the first anti-reflective coating, such as, at least about 11 wt. % or at least about 12 wt. % or at least about 13 wt. % or at least about 14 wt. % or at least about 15 wt. % or at least about 16 wt. % or at least about 17 wt. % or at least about 18 wt. % or at least about 19 wt. % or even at least about 20 wt. %. According to still other embodiments, the first anti-reflective coating 120 may have a first anti-smudge additive concentration of not greater than about 40 wt. % for a total weight of the first anti-reflective coating, such as, not greater than about 39 wt. % or not greater than about 38 wt. % or not greater than about 37 wt. % or not greater than about 36 wt. % or not greater than about 35 wt. % or not greater than about 34 wt. % or not greater than about 33 wt. % or not greater than about 32 wt. % or not greater than about 31 wt. % or not greater than about 30 wt. % or not greater than about 29 wt. % or not greater than about 28 wt. % or not greater than about 27 wt. % or not greater than about 26 wt. % or even not greater than about 25 wt. %. It will be appreciated that the first anti-reflective coating 120 may have a first anti-smudge additive concentration within a range between any of the minimum and maximum values noted above. It will be further appreciated that the first anti-reflective coating 120 may have a first anti-smudge additive concentration of any value between any of the minimum and maximum values noted above.

According to still other embodiments, the first anti-reflective coating 120 may have a particular thickness. For example, the first anti-reflective coating 120 may have a thickness of at least about 50 nm, such as, at least about 60 nm or at least about 70 nm or at least about 80 nm or at least about 90 nm or at least about 100 nm or at least about 110 nm or at least about 120 nm or at least about 130 nm or at least about 140 nm or at least about 150 nm or at least about 160 nm or at least about 170 nm or at least about 180 nm or at least about 190 nm or even at least about 200 nm. According to yet other embodiments, the first anti-reflective coating 120 may have a thickness of not greater than about 500 nm or not greater than about 490 nm or not greater than about 480 nm or not greater than about 470 nm or not greater than about 460 nm or not greater than about 450 nm or not greater than about 440 nm or not greater than about 430 nm or not greater than about 420 nm or not greater than about 410 nm or not greater than about 400 nm or not greater than about 390 nm or not greater than about 380 nm or not greater than about 370 nm or not greater than about 360 nm or not greater than about 350 nm or not greater than about 340 nm or not greater than about 330 nm or not greater than about 320 nm or not greater than about 310 nm or even not greater than about 300 nm. It will be appreciated that the anti-reflective coating 120 may have a thickness within a range between any of the minimum and maximum values noted above. It will be further appreciated that the anti-reflective coating 120 may have a thickness of any value between any of the minimum and maximum values noted above.

According to still other embodiments, the first transparent substrate 110 may have a particular thickness. For example, the first transparent substrate 110 may have a thickness of at least about 5 mil, such as, at least about 6 mil or at least about 7 mil or at least about 8 mil or at least about 9 mil or even at least about 10 mil. According to yet other embodiments, the first transparent substrate 110 may have a thickness of not greater than about 15 mil, such as, not greater than about 14 mil or not greater than about 13 mil or not greater than about 12 mil or not greater than about 11 mil. It will be appreciated that the thickness of the first transparent substrate 110 may be within a range between, and including, any of the minimum and maximum values noted above. It will be further appreciated that the thickness of the first transparent substrate 110 may be any value between, and including, any of the minimum and maximum values noted above.

According to still other embodiments, the first transparent substrate 110 may be multiple transparent films laminated together by an adhesive. For example, the first transparent substrate 110 may be at least 2 films laminated together by an adhesive or at least 3 films laminated together by an adhesive or at least 4 films laminated together by an adhesive or at least 5 films laminated together by an adhesive or at least 6 films laminated together by an adhesive or at least 7 films laminated together by an adhesive or at least 8 films laminated together by an adhesive or at least 9 films laminated together by an adhesive or at least 10 films laminated together by an adhesive or at least 11 films laminated together by an adhesive or at least 12 films laminated together by an adhesive or at least 13 films laminated together by an adhesive or at least 14 or even 15 films laminated together.

According to yet other embodiments, the first transparent substrate 110 may include a polyethylene terephthalate (PET) film. According to still other embodiments, the first transparent substrate 110 may consist of a PET film. According to other embodiments, the transparent substrate 110 may include an optically clear PET film. According to yet other embodiments, the transparent substrate 110 may consist of an optically clear PET film. According to other embodiments, the transparent substrate 110 may include a single layer optically clear PET film. According to yet other embodiments, the transparent substrate 110 may consist of a single layer optically clear PET film.

According to still other embodiments, the PET film of the first transparent substrate 110 may have a particular thickness. For example, the PET film of the first transparent substrate 110 may have a thickness of at least about 5 mil, such as, at least about 6 mil or at least about 7 mil or at least about 8 mil or at least about 9 mil or even at least about 10 mil. According to yet other embodiments, the PET film of the first transparent substrate 110 may have a thickness of not greater than about 15 mil, such as, not greater than about 14 mil or not greater than about 13 mil or not greater than about 12 mil or not greater than about 11 mil. It will be appreciated that the thickness of the PET film of the first transparent substrate 110 may be within a range between, and including, any of the minimum and maximum values noted above. It will be further appreciated that the thickness of the PET film of the first transparent substrate 110 may be any value between, and including, any of the minimum and maximum values noted above.

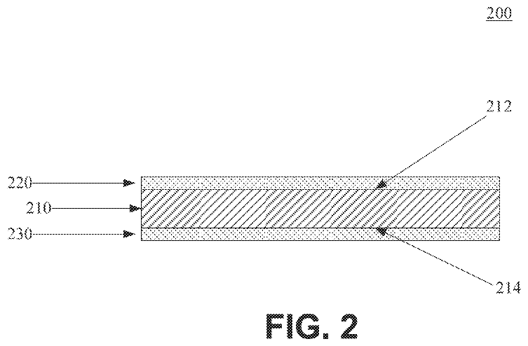

FIG. 2 includes an illustration of a cross-sectional view of a portion of another example composite film 200 according to embodiments described herein. As shown in FIG. 2, the composite film 200 may include a first transparent substrate 210, a first anti-reflective coating 220 overlying a first surface 212 of the first transparent substrate 210 and a second anti-reflective coating 230 overlying a second surface 214 of the first transparent substrate 201.

It will be appreciated that the composite film 200 and all components described in reference to the composite film 200 as shown in FIG. 2 may have any of the characteristics described herein with reference to corresponding components in FIG. 1. In particular, the characteristics of the composite film 200, the transparent substrate 210, and the first anti-reflective coating 220 shown in FIG. 2 may have any of the corresponding characteristics described herein in reference to composite film 100, the transparent substrate 110, and the first anti-reflective coating 120 shown in FIG. 2, respectively.

According to certain embodiments, the composite film 200 may have a particular VLT. For example, the composite film 200 may have VLT of at least about 94.0%, such as, at least about 94.5% or at least about 95.5% or at least about 96.0% or at least about 96.5% or at least about 97.0% or at least about 97.5% or at least about 98.0% or at least about 98.5% or even at least about 99%. According to yet other embodiments, the composite film 200 may have a VLT of not greater than about 99.9%, such as, not greater than about 99.8% or even not greater than about 99.7%. It will be appreciated that the composite film 200 may have a VLT within a range between any of the minimum and maximum values noted above. It will be further appreciated that the composite film 200 may have a VLT of any value between any of the minimum and maximum values noted above.

According to still other embodiments, the composite film 200 may have a particular haze. For example, the composite film 200 may have a haze of at least about 0.5%, such as, at least about 0.6% or at least about 0.7% or even at least about 0.8%. According to still other embodiments, the composite film 200 may have a haze of not greater than about 2.0%, such as, not greater than about 1.9% or not greater than about 1.8% or not greater than about 1.7% or not greater than about 1.6% or even not greater than about 1.5%. It will be appreciated that the composite film 200 may have a haze within a range between any of the minimum and maximum values noted above. It will be further appreciated that the composite film 200 may have a haze of any value between any of the minimum and maximum values noted above.

According to yet other embodiments, the composite film 200 may have a particular reflectance. For example, the composite film 200 may have a reflectance of at least about 1.5% as measured at 550 nm, such as, at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or even at least about 3.5%. According to still other embodiments, the composite film 200 may have a reflectance of not greater than about 7.0% as measured at 550 nm, such as, not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or even not greater than about 5.0%. It will be appreciated that the composite film 200 may have a reflectance within a range between any of the minimum and maximum values noted above. It will be further appreciated that the composite film 200 may have a reflectance of any value between any of the minimum and maximum values noted above.

According to yet other embodiments the second anti-reflective coating 230 may have a particular second binder component concentration. For example, the second anti-reflective coating 230 may have a second binder component concentration of at least about 30 wt. % for a total weight of the second anti-reflective coating, such as, at least about 31.0 wt. % or at least about 32.0 wt. % or at least about 33.0 wt. % or at least about 34.0 wt. % or at least about wt. % or at least about 36.0 wt. % or at least about 37.0 wt. % or at least about 38.0 wt. % or at least about 39.0 wt. % or at least about 40.0 wt. % or at least about 41.0 wt. % or at least about 42.0 wt. % or at least about 43.0 wt. % or even at least about 44.0 wt. %. According to still other embodiments, the second anti-reflective coating 230 may have a second binder component concentration of not greater than about 60 wt. % for a total weight of the second anti-reflective coating, such as, not greater than about 59 wt. % or not greater than about 58.0 wt. % or not greater than about 57.0 wt. % or not greater than about 56.0 wt. % or not greater than about 55.0 wt. % or not greater than about 54.0 wt. % or not greater than about 53.0 wt. % or not greater than about 52.0 wt. % or not greater than about 51.0 wt. % or not greater than about 50.0 wt. % or not greater than about 49.0 wt. % or even not greater than about 48.0 wt. %. It will be appreciated that the second anti-reflective coating 230 may have a second binder component concentration within a range between any of the minimum and maximum values noted above. It will be further appreciated that the second anti-reflective coating 230 may have a second binder component concentration of any value between any of the minimum and maximum values noted above.

According to particular embodiments, the second binder component may include particular materials. For example, the second binder component may include a UV curable binder. According to still other embodiments, the second binder component may include a UV curable acrylate, such as urethane acrylate, epoxy acrylate, polyester acrylate, silicone acrylate and fluorinated acrylate.

According to still other embodiments, the second binder component may include other particular materials. For example, the second binder component may include a curable polymeric binder. According to certain embodiments, the second binder component may include an acrylic binder, a polyester binder, epoxy binder.

According to yet other embodiments the second anti-reflective coating 230 may have a particular second particulate filler component concentration. For example, the second anti-reflective coating 230 may have a second particulate filler component concentration of at least about 40 wt. % for a total weight of the second anti-reflective coating, such as, at least about 41.0 wt. % or at least about 42.0 wt. % or at least about 43.0 wt. % or at least about 44.0 wt. % or at least about 45.0 wt. % or at least about 46.0 wt. % or at least about 47.0 wt. % or at least about 48.0 wt. % or at least about 49.0 wt. % or at least about 50.0 wt. % or at least about 51.0 wt. % or at least about 52.0 wt. % or at least about 53.0 wt. % or even at least about 54.0 wt. %. According to still other embodiments, the second anti-reflective coating 230 may have a second particulate filler component concentration of not greater than about 70 wt. % for a total weight of the second anti-reflective coating, such as, not greater than about 69 wt. % or not greater than about 68.0 wt. % or not greater than about 67.0 wt. % or not greater than about 66.0 wt. % or not greater than about 65.0 wt. % or not greater than about 64.0 wt. % or not greater than about 63.0 wt. % or not greater than about 62.0 wt. % or not greater than about 61.0 wt. % or not greater than about 60.0 wt. % or not greater than about 59.0 wt. % or even not greater than about 58.0 wt. %. It will be appreciated that the second anti-reflective coating 230 may have a second particulate filler component concentration within a range between any of the minimum and maximum values noted above. It will be further appreciated that the second anti-reflective coating 230 may have a second particulate filler component concentration of any value between any of the minimum and maximum values noted above.

According to yet other embodiments, the second particulate filler component may have a particular average particle size as measured by using a Microtrac particle analyzer. For example, the second particulate filler component may have an average particle size of at least about 120 nm, such as, at least about 125 nm or at least about 130 nm or at least about 135 nm or at least about 140 nm or at least about 145 nm or at least about 150 nm or at least about 155 nm or even at least about 160 nm. According to yet other embodiments, the second particulate filler component may have an average particle size of not greater than about 200 nm, such as, not greater than about 195 nm or not greater than about 190 nm or not greater than about 185 or not greater than about 180 nm or not greater than about 175 nm or even not greater than about 170 nm. It will be appreciated that the average particle size of the second particulate filler component may be within a range between any of the minimum and maximum values noted above. It will be further appreciated that the average particle size of the second particulate filler component may be any value between any of the minimum and maximum values noted above.

According to particular embodiments the second filler component may include hollow silica nanoparticles. According to other embodiments, the hollow silica nanoparticles may be spherical nanoparticles.

According to yet other embodiments, the hollow silica nanoparticles may have a particular average particle size as measured by using a Microtrac particle analyzer. For example, the hollow silica nanoparticles may have an average particle size of at least about 120 nm, such as, at least about 125 nm or at least about 130 nm or at least about 135 nm or at least about 140 nm or at least about 145 nm or at least about 150 nm or at least about 155 nm or even at least about 160 nm. According to yet other embodiments, the hollow silica nanoparticles may have an average particle size of not greater than about 200 nm, such as, not greater than about 195 nm or not greater than about 190 nm or not greater than about 185 or not greater than about 180 nm or not greater than about 175 nm or even not greater than about 170 nm. It will be appreciated that the average particle size of the hollow silica nanoparticles may be within a range between any of the minimum and maximum values noted above. It will be further appreciated that the average particle size of the hollow silica nanoparticles may be any value between any of the minimum and maximum values noted above.

According to other embodiments the second anti-reflective coating 230 may have a particular hollow silica nanoparticle concentration. For example, the second anti-reflective coating 230 may have a hollow silica nanoparticle concentration of at least about 40 wt. % for a total weight of the second anti-reflective coating, such as, at least about 41.0 wt. % or at least about 42.0 wt. % or at least about 43.0 wt. % or at least about 44.0 wt. % or at least about wt. % or at least about 46.0 wt. % or at least about 47.0 wt. % or at least about 48.0 wt. % or at least about 49.0 wt. % or at least about 50.0 wt. % or at least about 51.0 wt. % or at least about 52.0 wt. % or at least about 53.0 wt. % or even at least about 54.0 wt. %. According to still other embodiments, the second anti-reflective coating 230 may have a hollow silica nanoparticle concentration of not greater than about 70 wt. % for a total weight of the second anti-reflective coating, such as, not greater than about 69 wt. % or not greater than about 68.0 wt. % or not greater than about 67.0 wt. % or not greater than about 66.0 wt. % or not greater than about 65.0 wt. % or not greater than about 64.0 wt. % or not greater than about 63.0 wt. % or not greater than about 62.0 wt. % or not greater than about 61.0 wt. % or not greater than about 60.0 wt. % or not greater than about 59.0 wt. % or even not greater than about 58.0 wt. %. It will be appreciated that the second anti-reflective coating 230 may have a hollow silica nanoparticle concentration within a range between any of the minimum and maximum values noted above. It will be further appreciated that the second anti-reflective coating 230 may have a hollow silica nanoparticle concentration of any value between any of the minimum and maximum values noted above.

According to other embodiments, the second anti-reflective coating 230 may further include a second anti-smudge additive.

According to particular embodiments, the second anti-smudge additive may include silicone acrylate, a fluoro acrylate, or a fluorinated poly(meth)acrylate.

According to yet other embodiments the second anti-reflective coating 230 may have a particular second anti-smudge additive concentration. For example, the second anti-reflective coating 230 may have a second anti-smudge additive concentration of at least about wt. % for a total weight of the second anti-reflective coating, such as, at least about 11 wt. % or at least about 12 wt. % or at least about 13 wt. % or at least about 14 wt. % or at least about 15 wt. % or at least about 16 wt. % or at least about 17 wt. % or at least about 18 wt. % or at least about 19 wt. % or even at least about 20 wt. %. According to still other embodiments, the second anti-reflective coating 230 may have a second anti-smudge additive concentration of not greater than about 40 wt. % for a total weight of the second anti-reflective coating, such as, not greater than about 39 wt. % or not greater than about 38 wt. % or not greater than about 37 wt. % or not greater than about 36 wt. % or not greater than about 35 wt. % or not greater than about 34 wt. % or not greater than about 33 wt. % or not greater than about 32 wt. % or not greater than about 31 wt. % or not greater than about 30 wt. % or not greater than about 29 wt. % or not greater than about 28 wt. % or not greater than about 27 wt. % or not greater than about 26 wt. % or even not greater than about 25 wt. %. It will be appreciated that the second anti-reflective coating 230 may have a second anti-smudge additive concentration within a range between any of the minimum and maximum values noted above. It will be further appreciated that the second anti-reflective coating 230 may have a second anti-smudge additive concentration of any value between any of the minimum and maximum values noted above.

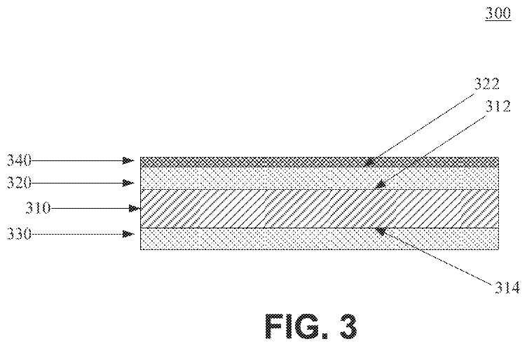

FIG. 3 includes an illustration of a cross-sectional view of a portion of another example composite film 300 according to embodiments described herein. As shown in FIG. 3, the composite film 300 may include a first transparent substrate 310, a first anti-reflective coating 320 overlying a first surface 312 of the first transparent substrate 310, a second anti-reflective coating 330 overlying a second surface 314 of the first transparent substrate 310 and a first adhesive layer 340 overlying a surface 322 of the first anti-reflective coating 320.

It will be appreciated that the composite film 300 and all components described in reference to the composite film 300 as shown in FIG. 3 may have any of the characteristics described herein with reference to corresponding components in FIGS. 1 and 2. In particular, the characteristics of the composite film 300, the transparent substrate 310, the first anti-reflective coating 320, and the second anti-reflective coating 330 shown in FIG. 3 may have any of the corresponding characteristics described herein in reference to composite films 200 (100), the transparent substrate 210 (110), the first anti-reflective coating 220 (120) and the second anti-reflective coating 230 shown in FIG. 2 (FIG. 1), respectively.

According to certain embodiments, the composite film 300 may have a particular VLT. For example, the composite film 300 may have VLT of at least about 94.0%, such as, at least about 94.5% or at least about 95.5% or at least about 96.0% or at least about 96.5% or at least about 97.0% or at least about 97.5% or at least about 98.0% or at least about 98.5% or even at least about 99%. According to yet other embodiments, the composite film 300 may have a VLT of not greater than about 99.9%, such as, not greater than about 99.8% or even not greater than about 99.7%. It will be appreciated that the composite film 300 may have a VLT within a range between any of the minimum and maximum values noted above. It will be further appreciated that the composite film 300 may have a VLT of any value between any of the minimum and maximum values noted above.

According to still other embodiments, the composite film 300 may have a particular haze. For example, the composite film 300 may have a haze of at least about 0.5%, such as, at least about 0.6% or at least about 0.7% or even at least about 0.8%. According to still other embodiments, the composite film 300 may have a haze of not greater than about 2.0%, such as, not greater than about 1.9% or not greater than about 1.8% or not greater than about 1.7% or not greater than about 1.6% or even not greater than about 1.5%. It will be appreciated that the composite film 300 may have a haze within a range between any of the minimum and maximum values noted above. It will be further appreciated that the composite film 300 may have a haze of any value between any of the minimum and maximum values noted above.

According to yet other embodiments, the composite film 300 may have a particular reflectance. For example, the composite film 300 may have a reflectance of at least about 1.5% as measured at 550 nm, such as, at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or even at least about 3.5%. According to still other embodiments, the composite film 300 may have a reflectance of not greater than about 7.0% as measured at 550 nm, such as, not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or even not greater than about 5.0%. It will be appreciated that the composite film 300 may have a reflectance within a range between any of the minimum and maximum values noted above. It will be further appreciated that the composite film 300 may have a reflectance of any value between any of the minimum and maximum values noted above.

According to still other embodiments, the first adhesive layer 340 may include any known pressure sensitive adhesive for use in the adhesive industry, for example, Aroset 1452, Aroset 1450, Aroset 6428 from Ashland, Duro-Tak 222A, Duro-Tak80-1093 or combinations thereof.

According to still other embodiments, the first adhesive layer 340 may have a particular thickness. For example, the first adhesive layer 340 may have a thickness of at least about 2 μm, such as, at least about 5 μm or at least about 7 μm or at least about 10 μm or at least about 12 μm or at least 15 μm or at least about 17 μm or even at least about 20 μm. According to still other embodiments, the first adhesive layer 340 may have a thickness of not greater than about 50 μm, such as, not greater than about 48 μm or not greater than about μm or not greater than about 43 μm or not greater than about 40 μm or not greater than about 38 μm or not greater than about 35 μm or not greater than about 33 μm or even not greater than about 30 μm. It will be appreciated that the first adhesive layer 340 may have a thickness within a range between, and including, any of the minimum and maximum values noted above. It will be further appreciated that the first adhesive layer 340 may have a thickness of any value between, and including, any of the minimum and maximum values noted above.

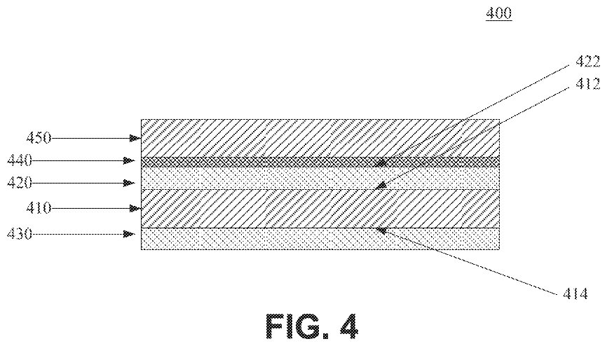

FIG. 4 includes an illustration of a cross-sectional view of a portion of another example composite film 400 according to embodiments described herein. As shown in FIG. 4, the composite film 400 may include a first transparent substrate 410, a first anti-reflective coating 420 overlying a first surface 412 of the first transparent substrate 410, a second anti-reflective coating 430 overlying a second surface 414 of the first transparent substrate 410, a first adhesive layer 440 overlying a surface 422 of the first anti-reflective coating 420 and a second transparent substrate 450 overlying the first adhesive layer 440.

It will be appreciated that the composite film 400 and all components described in reference to the composite film 400 as shown in FIG. 4 may have any of the characteristics described herein with reference to corresponding components in FIGS. 1, 2 and 3. In particular, the characteristics of the composite film 400, the transparent substrate 410, the first anti-reflective coating 420, the second anti-reflective coating 430 and the first adhesive layer 440 shown in FIG. 4 may have any of the corresponding characteristics described herein in reference to composite films 300 (200, 100), the transparent substrate 310 (210, 110), the first anti-reflective coating 320 (220, 120), the second anti-reflective coating 330 (230) and the first adhesive layer 340 shown in FIG. 3 (FIG. 2, FIG. 1), respectively.

According to certain embodiments, the composite film 400 may have a particular VLT. For example, the composite film 400 may have VLT of at least about 94.0%, such as, at least about 94.5% or at least about 95.5% or at least about 96.0% or at least about 96.5% or at least about 97.0% or at least about 97.5% or at least about 98.0% or at least about 98.5% or even at least about 99%. According to yet other embodiments, the composite film 400 may have a VLT of not greater than about 99.9%, such as, not greater than about 99.8% or even not greater than about 99.7%. It will be appreciated that the composite film 400 may have a VLT within a range between any of the minimum and maximum values noted above. It will be further appreciated that the composite film 400 may have a VLT of any value between any of the minimum and maximum values noted above.

According to still other embodiments, the composite film 400 may have a particular haze. For example, the composite film 400 may have a haze of at least about 0.5%, such as, at least about 0.6% or at least about 0.7% or even at least about 0.8%. According to still other embodiments, the composite film 400 may have a haze of not greater than about 2.0%, such as, not greater than about 1.9% or not greater than about 1.8% or not greater than about 1.7% or not greater than about 1.6% or even not greater than about 1.5%. It will be appreciated that the composite film 400 may have a haze within a range between any of the minimum and maximum values noted above. It will be further appreciated that the composite film 400 may have a haze of any value between any of the minimum and maximum values noted above.

According to yet other embodiments, the composite film 400 may have a particular reflectance. For example, the composite film 400 may have a reflectance of at least about 1.5% as measured at 550 nm, such as, at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or even at least about 3.5%. According to still other embodiments, the composite film 400 may have a reflectance of not greater than about 7.0% as measured at 550 nm, such as, not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or even not greater than about 5.0%. It will be appreciated that the composite film 400 may have a reflectance within a range between any of the minimum and maximum values noted above. It will be further appreciated that the composite film 400 may have a reflectance of any value between any of the minimum and maximum values noted above.

According to still other embodiments, the second transparent substrate 450 may have a particular thickness. For example, the second transparent substrate 450 may have a thickness of at least about 5 mil, such as, at least about 6 mil or at least about 7 mil or at least about 8 mil or at least about 9 mil or even at least about 10 mil. According to yet other embodiments, the second transparent substrate 450 may have a thickness of not greater than about 15 mil, such as, not greater than about 14 mil or not greater than about 13 mil or not greater than about 12 mil or not greater than about 11 mil. It will be appreciated that the thickness of the second transparent substrate 450 may be within a range between, and including, any of the minimum and maximum values noted above. It will be further appreciated that the thickness of the second transparent substrate 450 may be any value between, and including, any of the minimum and maximum values noted above.

According to yet other embodiments, the second transparent substrate 450 may include a PET film. According to still other embodiments, the second transparent substrate 450 may consist of a PET film. According to other embodiments, the transparent substrate 110 may include an optically clear PET film. According to yet other embodiments, the transparent substrate 110 may consist of an optically clear PET film. According to other embodiments, the transparent substrate 110 may include a single layer optically clear PET film. According to yet other embodiments, the transparent substrate 110 may consist of a single layer optically clear PET film.

According to still other embodiments, the PET film of the second transparent substrate 450 may have a particular thickness. For example, the PET film of the second transparent substrate 450 may have a thickness of at least about 5 mil, such as, at least about 6 mil or at least about 7 mil or at least about 8 mil or at least about 9 mil or even at least about 10 mil. According to yet other embodiments, the PET film of the second transparent substrate 450 may have a thickness of not greater than about 15 mil, such as, not greater than about 14 mil or not greater than about 13 mil or not greater than about 12 mil or not greater than about 11 mil. It will be appreciated that the thickness of the PET film of the second transparent substrate 450 may be within a range between, and including, any of the minimum and maximum values noted above. It will be further appreciated that the thickness of the PET film of the second transparent substrate 450 may be any value between, and including, any of the minimum and maximum values noted above.

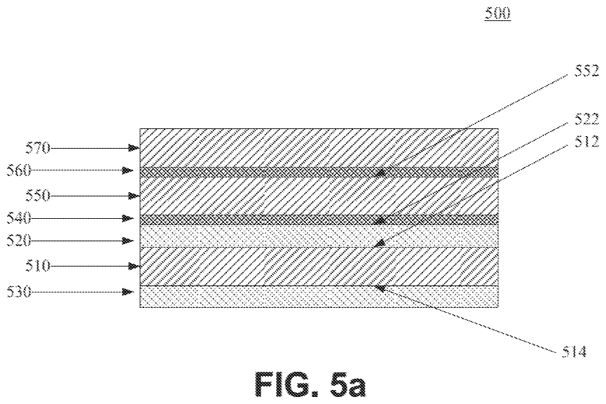

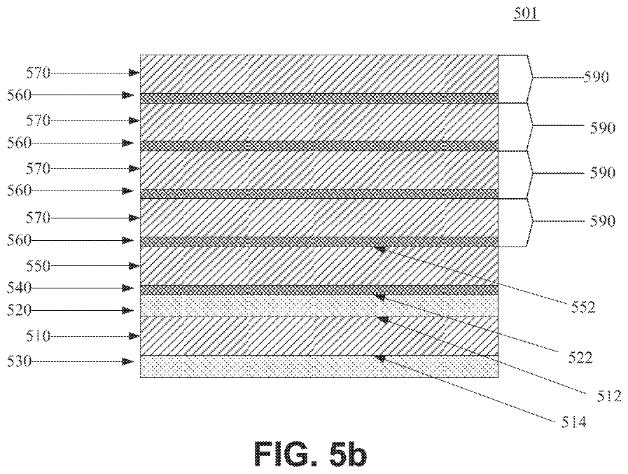

FIG. 5a includes an illustration of a cross-sectional view of a portion of another example composite film 500 according to embodiments described herein. As shown in FIG. the composite film 500 may include a first transparent substrate 510, a first anti-reflective coating 520 overlying a first surface 512 of the first transparent substrate 510, a second anti-reflective coating 530 overlying a second surface 514 of the first transparent substrate 510, a first adhesive layer 540 overlying a surface 522 of the first anti-reflective coating 520, a second transparent substrate 550 overlying the first adhesive layer 540, a second adhesive layer 560 overlying a surface 552 of the second transparent substrate 550, and a third transparent substrate 570 overlying the second adhesive layer 560.

It will be appreciated that the composite film 500 and all components described in reference to the composite film 500 as shown in FIG. 5a may have any of the characteristics described herein with reference to corresponding components in FIGS. 1, 2, 3 and 4. In particular, the characteristics of the composite film 500, the transparent substrate 510, the first anti-reflective coating 520, the second anti-reflective coating 530, the first adhesive layer 540 and the second transparent substrate 550 shown in FIG. 5a may have any of the corresponding characteristics described herein in reference to composite films 400 (300, 200, 100), the transparent substrate 410 (310, 210, 110), the first anti-reflective coating 420 (320, 220, 120), the second anti-reflective coating 430 (330, 230), the first adhesive layer 440 (340) and the second transparent substrate 450 shown in FIG. 4 (FIG. 3, FIG. 2, FIG. 1), respectively.

According to certain embodiments, the composite film 500 may have a particular VLT. For example, the composite film 500 may have VLT of at least about 94.0%, such as, at least about 94.5% or at least about 95.5% or at least about 96.0% or at least about 96.5% or at least about 97.0% or at least about 97.5% or at least about 98.0% or at least about 98.5% or even at least about 99%. According to yet other embodiments, the composite film 500 may have a VLT of not greater than about 99.9%, such as, not greater than about 99.8% or even not greater than about 99.7%. It will be appreciated that the composite film 500 may have a VLT within a range between any of the minimum and maximum values noted above. It will be further appreciated that the composite film 500 may have a VLT of any value between any of the minimum and maximum values noted above.

According to still other embodiments, the composite film 500 may have a particular haze. For example, the composite film 500 may have a haze of at least about 0.5%, such as, at least about 0.6% or at least about 0.7% or even at least about 0.8%. According to still other embodiments, the composite film 500 may have a haze of not greater than about 2.0%, such as, not greater than about 1.9% or not greater than about 1.8% or not greater than about 1.7% or not greater than about 1.6% or even not greater than about 1.5%. It will be appreciated that the composite film 500 may have a haze within a range between any of the minimum and maximum values noted above. It will be further appreciated that the composite film 500 may have a haze of any value between any of the minimum and maximum values noted above.

According to yet other embodiments, the composite film 500 may have a particular reflectance. For example, the composite film 500 may have a reflectance of at least about 1.5% as measured at 550 nm, such as, at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or even at least about 3.5%. According to still other embodiments, the composite film 500 may have a reflectance of not greater than about 7.0% as measured at 550 nm, such as, not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or even not greater than about 5.0%. It will be appreciated that the composite film 500 may have a reflectance within a range between any of the minimum and maximum values noted above. It will be further appreciated that the composite film 500 may have a reflectance of any value between any of the minimum and maximum values noted above.

According to still other embodiments, the second adhesive layer 560 may include any known pressure sensitive adhesive for use in the adhesive industry, for example, Aroset 1452, Aroset 1450, Aroset 6428 from Ashland, Duro-Tak 222A, Duro-Tak80-1093 or combinations thereof.

According to still other embodiments, the second adhesive layer 560 may have a particular thickness. For example, the second adhesive layer 560 may have a thickness of at least about 2 μm, such as, at least about 5 μm or at least about 7 μm or at least about 10 μm or at least about 12 μm or at least 15 μm or at least about 17 μm or even at least about 20 μm. According to still other embodiments, the second adhesive layer 560 not greater than about μm, such as, not greater than about 48 μm or not greater than about 45 μm or not greater than about 43 μm or not greater than about 40 μm or not greater than about 38 μm or not greater than about 35 μm or not greater than about 33 μm or even not greater than about 30 μm. It will be appreciated that the second adhesive layer 560 may have a thickness within a range between, and including, any of the minimum and maximum values noted above. It will be further appreciated that the second adhesive layer 560 may have a thickness of any value between, and including, any of the minimum and maximum values noted above.

According to still other embodiments, the third transparent substrate 570 may have a particular thickness. For example, the third transparent substrate 570 may have a thickness of at least about 5 mil, such as, at least about 6 mil or at least about 7 mil or at least about 8 mil or at least about 9 mil or even at least about 10 mil. According to yet other embodiments, the third transparent substrate 570 may have a thickness of not greater than about 15 mil, such as, not greater than about 14 mil or not greater than about 13 mil or not greater than about 12 mil or not greater than about 11 mil. It will be appreciated that the thickness of the third transparent substrate 570 may be within a range between, and including, any of the minimum and maximum values noted above. It will be further appreciated that the thickness of the third transparent substrate 570 may be any value between, and including, any of the minimum and maximum values noted above.

According to yet other embodiments, the third transparent substrate 570 may include a PET film. According to still other embodiments, the third transparent substrate 570 may consist of a PET film. According to other embodiments, the transparent substrate 110 may include an optically clear PET film. According to yet other embodiments, the transparent substrate 110 may consist of an optically clear PET film. According to other embodiments, the transparent substrate 110 may include a single layer optically clear PET film. According to yet other embodiments, the transparent substrate 110 may consist of a single layer optically clear PET film.

According to still other embodiments, the PET film of the third transparent substrate 570 may have a particular thickness. For example, the PET film of the third transparent substrate 570 may have a thickness of at least about 5 mil, such as, at least about 6 mil or at least about 7 mil or at least about 8 mil or at least about 9 mil or even at least about 10 mil. According to yet other embodiments, the PET film of the third transparent substrate 570 may have a thickness of not greater than about 15 mil, such as, not greater than about 14 mil or not greater than about 13 mil or not greater than about 12 mil or not greater than about 11 mil. It will be appreciated that the thickness of the PET film of the third transparent substrate 570 may be within a range between, and including, any of the minimum and maximum values noted above. It will be further appreciated that the thickness of the PET film of the third transparent substrate 570 may be any value between, and including, any of the minimum and maximum values noted above.

FIG. 5b includes an illustration of a cross-sectional view of a portion of another example composite film 501 according to embodiments described herein. As shown in FIG. the composite film 501 may include a first transparent substrate 510, a first anti-reflective coating 520 overlying a first surface 512 of the first transparent substrate 510, a second anti-reflective coating 530 overlying a second surface 514 of the first transparent substrate 510, a first adhesive layer 540 overlying a surface 522 of the first anti-reflective coating 520, a second transparent substrate 550 overlying the first adhesive layer 540, and four repeating top transparent substrate components 590, which each include a third transparent substrate 570 overlying a second adhesive layer 560.

It will be appreciated that the number of repeating top transparent substrate components 590 shown in FIG. 5b is illustrative and not intended to be limiting. According to particular embodiments, a composite film 501 according to embodiments described herein may include a particular number of repeating top layer components, such as, at least 3 repeating top transparent substrate components 590 or at least 4 repeating top transparent substrate components 590 or at least 5 repeating top transparent substrate components 590 or at least 6 repeating top transparent substrate components 590 or at least 7 repeating top transparent substrate components 590 or at least 8 repeating top transparent substrate components 590 or at least 9 repeating top transparent substrate components 590 or at least repeating top transparent substrate components 590.

According to certain embodiments, the composite film 501 may have a particular VLT. For example, the composite film 501 may have VLT of at least about 94.0%, such as, at least about 94.5% or at least about 95.5% or at least about 96.0% or at least about 96.5% or at least about 97.0% or at least about 97.5% or at least about 98.0% or at least about 98.5% or even at least about 99%. According to yet other embodiments, the composite film 501 may have a VLT of not greater than about 99.9%, such as, not greater than about 99.8% or even not greater than about 99.7%. It will be appreciated that the composite film 501 may have a VLT within a range between any of the minimum and maximum values noted above. It will be further appreciated that the composite film 501 may have a VLT of any value between any of the minimum and maximum values noted above.

According to still other embodiments, the composite film 501 may have a particular haze. For example, the composite film 501 may have a haze of at least about 0.5%, such as, at least about 0.6% or at least about 0.7% or even at least about 0.8%. According to still other embodiments, the composite film 501 may have a haze of not greater than about 2.0%, such as, not greater than about 1.9% or not greater than about 1.8% or not greater than about 1.7% or not greater than about 1.6% or even not greater than about 1.5%. It will be appreciated that the composite film 501 may have a haze within a range between any of the minimum and maximum values noted above. It will be further appreciated that the composite film 501 may have a haze of any value between any of the minimum and maximum values noted above.

According to yet other embodiments, the composite film 501 may have a particular reflectance. For example, the composite film 501 may have a reflectance of at least about 1.5% as measured at 550 nm, such as, at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or even at least about 3.5%. According to still other embodiments, the composite film 501 may have a reflectance of not greater than about 7.0% as measured at 550 nm, such as, not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or even not greater than about 5.0%. It will be appreciated that the composite film 501 may have a reflectance within a range between any of the minimum and maximum values noted above. It will be further appreciated that the composite film 501 may have a reflectance of any value between any of the minimum and maximum values noted above.

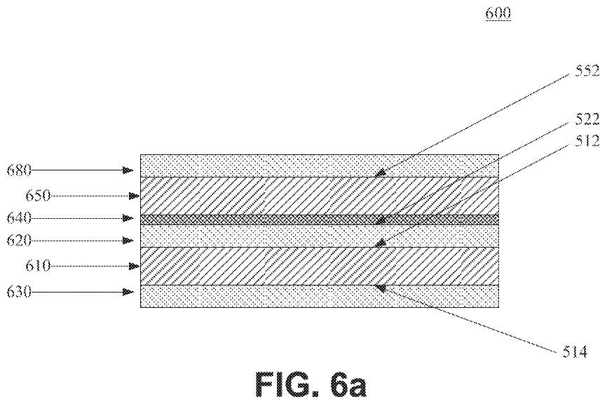

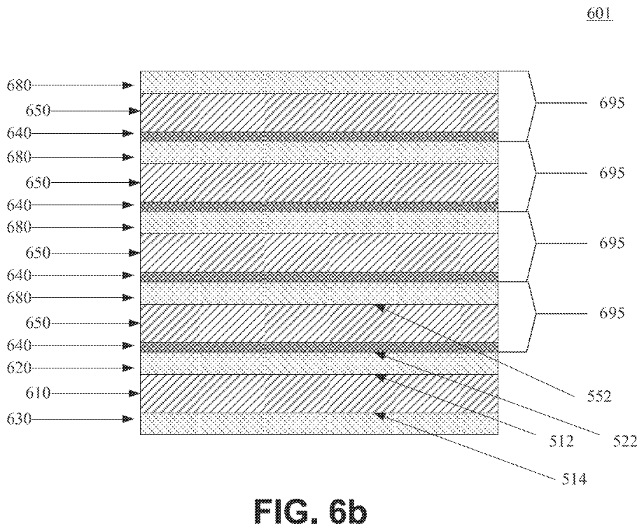

FIG. 6a includes an illustration of a cross-sectional view of a portion of another example composite film 600 according to embodiments described herein. As shown in FIG. 6a, the composite film 600 may include a first transparent substrate 610, a first anti-reflective coating 620 overlying a first surface 612 of the first transparent substrate 610, a second anti-reflective coating 630 overlying a second surface 614 of the first transparent substrate 610, a first adhesive layer 640 overlying a surface 622 of the first anti-reflective coating 620, a second transparent substrate 650 overlying the first adhesive layer 640, and a third anti-reflective coating 680 overlying a surface 652 of the second transparent substrate 650.

It will be appreciated that the composite film 600 and all components described in reference to the composite film 600 as shown in FIG. 6a may have any of the characteristics described herein with reference to corresponding components in FIGS. 1, 2, 3, 4, 5a and 5b. In particular, the characteristics of the composite film 600, the transparent substrate 610, the first anti-reflective coating 620, the second anti-reflective coating 630, the first adhesive layer 640 and the second transparent substrate 650 shown in FIG. 6a may have any of the corresponding characteristics described herein in reference to composite films 500 (400, 300, 200, 100), the transparent substrate 510 (410, 310, 210, 110), the first anti-reflective coating 520 (420, 320, 220, 120), the second anti-reflective coating 530 (430, 330, 230), the first adhesive layer 540 (440, 340) and the second transparent substrate 550 (450) shown in FIG. or 5b (FIG. 4, FIG. 3, FIG. 2, FIG. 1), respectively.

According to yet other embodiments the third anti-reflective coating 680 may have a particular third binder component concentration. For example, the third anti-reflective coating 680 may have a third binder component concentration of at least about 30 wt. % for a total weight of the third anti-reflective coating, such as, at least about 31.0 wt. % or at least about 32.0 wt. % or at least about 33.0 wt. % or at least about 34.0 wt. % or at least about 35.0 wt. % or at least about 36.0 wt. % or at least about 37.0 wt. % or at least about 38.0 wt. % or at least about 39.0 wt. % or at least about 40.0 wt. % or at least about 41.0 wt. % or at least about 42.0 wt. % or at least about 43.0 wt. % or even at least about 44.0 wt. %. According to still other embodiments, the third anti-reflective coating 680 may have a third binder component concentration of not greater than about 60 wt. % for a total weight of the third anti-reflective coating, such as, not greater than about 59 wt. % or not greater than about 58.0 wt. % or not greater than about 57.0 wt. % or not greater than about 56.0 wt. % or not greater than about wt. % or not greater than about 54.0 wt. % or not greater than about 53.0 wt. % or not greater than about 52.0 wt. % or not greater than about 51.0 wt. % or not greater than about wt. % or not greater than about 49.0 wt. % or even not greater than about 48.0 wt. %. It will be appreciated that the third anti-reflective coating 680 may have a third binder component concentration within a range between any of the minimum and maximum values noted above. It will be further appreciated that the third anti-reflective coating 680 may have a third binder component concentration of any value between any of the minimum and maximum values noted above.

According to particular embodiments, the third binder component may include particular materials. For example, the third binder component may include a UV curable binder. According to still other embodiments, the third binder component may include a UV curable acrylate, such as urethane acrylate, epoxy acrylate, polyester acrylate, silicone acrylate and fluorinated acrylate.

According to still other embodiments, the third binder component may include other particular materials. For example, the third binder component may include a curable polymeric binder. According to certain embodiments, the third binder component may include an acrylic binder, a polyester binder, epoxy binder.

According to yet other embodiments the third anti-reflective coating 680 may have a particular third particulate filler component concentration. For example, the third anti-reflective coating 680 may have a third particulate filler component concentration of at least about 40 wt. % for a total weight of the third anti-reflective coating, such as, at least about 41.0 wt. % or at least about 42.0 wt. % or at least about 43.0 wt. % or at least about 44.0 wt. % or at least about 45.0 wt. % or at least about 46.0 wt. % or at least about 47.0 wt. % or at least about 48.0 wt. % or at least about 49.0 wt. % or at least about 50.0 wt. % or at least about 51.0 wt. % or at least about 52.0 wt. % or at least about 53.0 wt. % or even at least about 54.0 wt. %. According to still other embodiments, the third anti-reflective coating 680 may have a third particulate filler component concentration of not greater than about 70 wt. % for a total weight of the third anti-reflective coating, such as, not greater than about 69 wt. % or not greater than about 68.0 wt. % or not greater than about 67.0 wt. % or not greater than about 66.0 wt. % or not greater than about 65.0 wt. % or not greater than about 64.0 wt. % or not greater than about 63.0 wt. % or not greater than about 62.0 wt. % or not greater than about 61.0 wt. % or not greater than about 60.0 wt. % or not greater than about 59.0 wt. % or even not greater than about 58.0 wt. %. It will be appreciated that the third anti-reflective coating 680 may have a third particulate filler component concentration within a range between any of the minimum and maximum values noted above. It will be further appreciated that the third anti-reflective coating 680 may have a third particulate filler component concentration of any value between any of the minimum and maximum values noted above.

According to yet other embodiments, the third particulate filler component may have a particular average particle size as measured by using a Microtrac particle analyzer. For example, the third particulate filler component may have an average particle size of at least about 120 nm, such as, at least about 125 nm or at least about 130 nm or at least about 135 nm or at least about 140 nm or at least about 145 nm or at least about 150 nm or at least about 155 nm or even at least about 160 nm. According to yet other embodiments, the third particulate filler component may have an average particle size of not greater than about 200 nm, such as, not greater than about 195 nm or not greater than about 190 nm or not greater than about 185 or not greater than about 180 nm or not greater than about 175 nm or even not greater than about 170 nm. It will be appreciated that the average particle size of the third particulate filler component may be within a range between any of the minimum and maximum values noted above. It will be further appreciated that the average particle size of the third particulate filler component may be any value between any of the minimum and maximum values noted above.

According to particular embodiments the third filler component may include hollow silica nanoparticles. According to other embodiments, the hollow silica nanoparticles may be spherical nanoparticles.

According to yet other embodiments, the hollow silica nanoparticles may have a particular average particle size as measured by using a Microtrac particle analyzer. For example, the hollow silica nanoparticles may have an average particle size of at least about 120 nm, such as, at least about 125 nm or at least about 130 nm or at least about 135 nm or at least about 140 nm or at least about 145 nm or at least about 150 nm or at least about 155 nm or even at least about 160 nm. According to yet other embodiments, the hollow silica nanoparticles may have an average particle size of not greater than about 200 nm, such as, not greater than about 195 nm or not greater than about 190 nm or not greater than about 185 nm or not greater than about 180 nm or not greater than about 175 nm or even not greater than about 170 nm. It will be appreciated that the average particle size of the hollow silica nanoparticles may be within a range between any of the minimum and maximum values noted above. It will be further appreciated that the average particle size of the hollow silica nanoparticles may be any value between any of the minimum and maximum values noted above.

According to other embodiments the third anti-reflective coating 680 may have a particular hollow silica nanoparticle concentration. For example, the third anti-reflective coating 680 may have a hollow silica nanoparticle concentration of at least about 40 wt. % for a total weight of the third anti-reflective coating, such as, at least about 41.0 wt. % or at least about 42.0 wt. % or at least about 43.0 wt. % or at least about 44.0 wt. % or at least about 45.0 wt. % or at least about 46.0 wt. % or at least about 47.0 wt. % or at least about 48.0 wt. % or at least about 49.0 wt. % or at least about 50.0 wt. % or at least about 51.0 wt. % or at least about 52.0 wt. % or at least about 53.0 wt. % or even at least about 54.0 wt. %. According to still other embodiments, the third anti-reflective coating 680 may have a hollow silica nanoparticle concentration of not greater than about 70 wt. % for a total weight of the third anti-reflective coating, such as, not greater than about 69 wt. % or not greater than about 68.0 wt. % or not greater than about 67.0 wt. % or not greater than about 66.0 wt. % or not greater than about 65.0 wt. % or not greater than about 64.0 wt. % or not greater than about 63.0 wt. % or not greater than about 62.0 wt. % or not greater than about 61.0 wt. % or not greater than about 60.0 wt. % or not greater than about 59.0 wt. % or even not greater than about 58.0 wt. %. It will be appreciated that the third anti-reflective coating 680 may have a hollow silica nanoparticle concentration within a range between any of the minimum and maximum values noted above. It will be further appreciated that the third anti-reflective coating 680 may have a hollow silica nanoparticle concentration of any value between any of the minimum and maximum values noted above.

According to other embodiments, the third anti-reflective coating 680 may further include a third anti-smudge additive.

According to particular embodiments, the third anti-smudge additive may include silicone acrylate, a fluoro acrylate, or a fluorinated poly(meth)acrylate.

According to yet other embodiments the third anti-reflective coating 680 may have a particular third anti-smudge additive concentration. For example, the third anti-reflective coating 680 may have a third anti-smudge additive concentration of at least about 10 wt. % for a total weight of the third anti-reflective coating, such as, at least about 11 wt. % or at least about 12 wt. % or at least about 13 wt. % or at least about 14 wt. % or at least about 15 wt. % or at least about 16 wt. % or at least about 17 wt. % or at least about 18 wt. % or at least about 19 wt. % or even at least about 20 wt. %. According to still other embodiments, the third anti-reflective coating 680 may have a third anti-smudge additive concentration of not greater than about 40 wt. % for a total weight of the third anti-reflective coating, such as, not greater than about 39 wt. % or not greater than about 38 wt. % or not greater than about 37 wt. % or not greater than about 36 wt. % or not greater than about 35 wt. % or not greater than about 34 wt. % or not greater than about 33 wt. % or not greater than about 32 wt. % or not greater than about 31 wt. % or not greater than about 30 wt. % or not greater than about 29 wt. % or not greater than about 28 wt. % or not greater than about 27 wt. % or not greater than about 26 wt. % or even not greater than about 25 wt. %. It will be further appreciated that the third anti-reflective coating 680 may have a third anti-smudge additive concentration of any value between any of the minimum and maximum values noted above.

FIG. 6b includes an illustration of a cross-sectional view of a portion of another example composite film 601 according to embodiments described herein. As shown in FIG. 6b, the composite film 601 may include a first transparent substrate 610, a first anti-reflective coating 620 overlying a first surface 612 of the first transparent substrate 610, a second anti-reflective coating 630 overlying a second surface 614 of the first transparent substrate 610, and four repeating top anti-reflective components 695 overlying a surface 622 of the first anti-reflective coating 620. Each repeating top anti-reflective components 695 may include a first adhesive layer 640, a second transparent substrate 650 overlying the first adhesive layer 640 and a third anti-reflective coating 680 overlying the second transparent substrate 650.

It will be appreciated that the number of repeating top anti-reflective components 695 shown in FIG. 6b is illustrative and not intended to be limiting. According to particular embodiments, a composite film 601 according to embodiments described herein may include a particular number of repeating top layer components, such as, at least 3 repeating top anti-reflective components 695 or at least 4 repeating top anti-reflective components 695 or at least 5 repeating top anti-reflective components 695 or at least 6 repeating top anti-reflective components 695 or at least 7 repeating top anti-reflective components 695 or at least 8 repeating top anti-reflective components 695 or at least 9 repeating top anti-reflective components 695 or at least 10 repeating top anti-reflective components 695.

According to certain embodiments, the composite film 601 may have a particular VLT. For example, the composite film 601 may have VLT of at least about 94.0%, such as, at least about 94.5% or at least about 95.5% or at least about 96.0% or at least about 96.5% or at least about 97.0% or at least about 97.5% or at least about 98.0% or at least about 98.5% or even at least about 99%. According to yet other embodiments, the composite film 601 may have a VLT of not greater than about 99.9%, such as, not greater than about 99.8% or even not greater than about 99.7%. It will be appreciated that the composite film 601 may have a VLT within a range between any of the minimum and maximum values noted above. It will be further appreciated that the composite film 601 may have a VLT of any value between any of the minimum and maximum values noted above.

According to still other embodiments, the composite film 601 may have a particular haze. For example, the composite film 601 may have a haze of at least about 0.5%, such as, at least about 0.6% or at least about 0.7% or even at least about 0.8%. According to still other embodiments, the composite film 601 may have a haze of not greater than about 2.0%, such as, not greater than about 1.9% or not greater than about 1.8% or not greater than about 1.7% or not greater than about 1.6% or even not greater than about 1.5%. It will be appreciated that the composite film 601 may have a haze within a range between any of the minimum and maximum values noted above. It will be further appreciated that the composite film 601 may have a haze of any value between any of the minimum and maximum values noted above.

According to yet other embodiments, the composite film 601 may have a particular reflectance. For example, the composite film 601 may have a reflectance of at least about 1.5% as measured at 550 nm, such as, at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or even at least about 3.5%. According to still other embodiments, the composite film 601 may have a reflectance of not greater than about 7.0% as measured at 550 nm, such as, not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or even not greater than about 5.0%. It will be appreciated that the composite film 601 may have a reflectance within a range between any of the minimum and maximum values noted above. It will be further appreciated that the composite film 601 may have a reflectance of any value between any of the minimum and maximum values noted above.

According to embodiments described herein, an anti-reflective coating as described herein may be applied to another layer, for example, a first transparent substrate or another coating, using wet coating methods, such as, Meyer rod methods, gravure methods, reverse gravure methods, mini gravure methods, slot die methods, spray coating methods or dip coating methods. According to yet other embodiments described herein, the newly applied coating may be dried in an oven to remove solvents. According to yet other embodiments, the dried coating may then be cured by UV light, electronic beam, and other high-energy beam heating.

According to still other embodiments, the pressure sensitive adhesive layers described herein may be applied a first transparent substrate or another coating, using wet coating methods, such as, Meyer rod methods, gravure methods, reverse gravure methods, mini gravure methods, slot die methods, spray coating methods or dip coating methods.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A composite film comprising: a first transparent substrate; and a first anti-reflective coating overlying a first surface of the first transparent substrate, wherein the first anti-reflective coating comprises a first binder component and a first particulate filler component, wherein the first particulate filler component comprises hollow silica nanoparticles, wherein the composite film has a VLT of at least about 94.0%, and wherein the composite film has a water contact angle of at least about 70°.

Embodiment 2. A composite film comprising: a first transparent substrate; and a first anti-reflective coating overlying a first surface of the first transparent substrate, wherein the first anti-reflective coating comprises a first binder component and a first particulate filler component, wherein the first particulate filler component comprises hollow silica nanoparticles, wherein the composite film has a VLT of at least about 94.0%, and wherein the composite film has a water contact angle of at least about 80°.

Embodiment 3. The composite film of any one of embodiments 1, and 2, wherein the composite film further comprises a VLT of at least about 94.0% or at least about 94.5% or at least about 95.5% or at least about 96.0% or at least about 96.5% or at least about 97.0% or at least about 97.5% or at least about 98.0% or at least about 98.5% or at least about 99%.

Embodiment 4. The composite film of any one of embodiments 1, and 2, wherein the composite film further comprises a VLT of not greater than about 99.9% or not greater than about 99.8% or not greater than about 99.7%.

Embodiment 5. The composite film of any one of embodiments 1, and 2, wherein the composite film further comprises a haze of at least about 0.5% or at least about 0.6% or at least about 0.7% or at least about 0.8%.

Embodiment 6. The composite film of any one of embodiments 1, and 2, wherein the composite film further comprises a haze of not greater than about 2.0% or not greater than about 1.9% or not greater than about 1.8% or not greater than about 1.7% or not greater than about 1.6% or not greater than about 1.5%.

Embodiment 7. The composite film of any one of embodiments 1, and 2, wherein the composite film further comprises a reflectance of at least about 1.5% as measured at 550 nm or at least about 1.6% or at least about 1.7% or at least about 1.8% or at least about 1.9% or at least about 2.0% or at least about 2.1% or at least about 2.2% or at least about 2.3% or at least about 2.4% or at least about 2.5% or at least about 2.6% or at least about 2.7% or at least about 2.8% or at least about 2.9% or at least about 3.0% or at least about 3.1% or at least about 3.2% or at least about 3.3% or at least about 3.4% or at least about 3.5%.

Embodiment 8. The composite film of any one of embodiments 1, and 2, wherein the composite film further comprises a reflectance of not greater than about 7.0% as measured at 550 nm or not greater than about 6.9% or not greater than about 6.8% or not greater than about 6.7% or not greater than about 6.6% or not greater than about 6.5% or not greater than about 6.4% or not greater than about 6.3% or not greater than about 6.2% or not greater than about 6.1% or not greater than about 6.0% or not greater than about 5.9% or not greater than about 5.8% or not greater than about 5.7% or not greater than about 5.6% or not greater than about 5.5% or not greater than about 5.4% or not greater than about 5.3% or not greater than about 5.2% or not greater than about 5.1% or not greater than about 5.0%.

Embodiment 9. The composite film of any one of embodiments 1, and 2, wherein the composite film comprises the first binder component at a concentration of at least about 30.0 wt. % for a total weight of the first anti-reflective coating.

Embodiment 10. The composite film of any one of embodiments 1, and 2, wherein the composite film comprises the first binder component at a concentration of not greater than about 60.0 wt. % for a total weight of the first anti-reflective coating.

Embodiment 11. The composite film of any one of embodiments 1, and 2, wherein the first binder component comprises a UV curable binder.

Embodiment 12. The composite film of embodiment 11, wherein the UV curable binder comprises a UV curable acrylate, such as urethane acrylate, epoxy acrylate, polyester acrylate, silicone acrylate and fluorinated acrylate.

Embodiment 13. The composite film of any one of embodiments 1, and 2, wherein the first binder component comprises a curable polymeric binder.

Embodiment 14. The composite film of embodiment 11, wherein the curable polymeric binder comprises an acrylic binder, a polyester binder, epoxy binder.

Embodiment 15. The composite film of any one of embodiments 1, and 2, wherein the composite film comprises the first particulate filler component at a concentration of at least about 40.0 wt. % for a total weight of the first anti-reflective coating.

Embodiment 16. The composite film of any one of embodiments 1, and 2, wherein the composite film comprises the first particulate filler component at a concentration of not greater than about 70.0 wt. % for a total weight of the first anti-reflective coating.

Embodiment 17. The composite film of any one of embodiments 1, and 2, wherein the composite film comprises the hollow silica nanoparticles at a concentration of at least about wt. % for a total weight of the first anti-reflective coating.

Embodiment 18. The composite film of any one of embodiments 1, and 2, wherein the composite film comprises a hollow silica nanoparticles at a concentration of not greater than about 70.0 wt. % for a total weight of the first anti-reflective coating.

Embodiment 19. The composite film of any one of embodiments 1, and 2, wherein the first particulate filler component has an average particle size of at least about 120 nm.

Embodiment 20. The composite film of any one of embodiments 1, and 2, wherein the first particulate filler component has an average particle size of not greater than about 200 nm.

Embodiment 21. The composite film of any one of embodiments 1, and 2, wherein the hollow silica nanoparticles has an average particle size of at least about 120 nm.

Embodiment 22. The composite film of any one of embodiments 1, and 2, wherein the hollow silica nanoparticles has an average particle size of not greater than about 200 nm.

Embodiment 23. The composite film of any one of embodiments 1, and 2, wherein the hollow silica nanoparticles are spherical nanoparticles.

Embodiment 24. The composite film of any one of embodiments 1, and 2, wherein the composite film further comprises a first anti-smudge additive.

Embodiment 25. The composite film of embodiment 24, wherein the composite film comprises the first anti-smudge additive a concentration of at least about 10 wt. % for a total weight of the first anti-reflective coating.

Embodiment 26. The composite film of embodiment 24, wherein the composite film comprises the first anti-smudge additive a concentration of not greater than about 40 wt. % for a total weight of the first anti-reflective coating.

Embodiment 27. The composite film of embodiment 24, wherein the first anti-smudge additive comprises a silicone acrylate, a fluoro acrylate, fluorinated poly(meth)acrylate.

Embodiment 28. The composite film of any one of the previous embodiments, wherein the first anti-reflective coating has a thickness of at least about 50 nm or at least about 60 nm or at least about 70 nm or at least about 80 nm or at least about 90 nm or at least about 100 nm or at least about 110 nm or at least about 120 nm or at least about 130 nm or at least about 140 nm or at least about 150 nm or at least about 160 nm or at least about 170 nm or at least about 180 nm or at least about 190 nm or at least about 200 nm.

Embodiment 29. The composite film of any one of the previous embodiments, wherein the first anti-reflective coating has a thickness of not greater than about 500 nm or not greater than about 490 nm or not greater than about 480 nm or not greater than about 470 nm or not greater than about 460 nm or not greater than about 450 nm or not greater than about 440 nm or not greater than about 430 nm or not greater than about 420 nm or not greater than about 410 nm or not greater than about 400 nm or not greater than about 390 nm or not greater than about 380 nm or not greater than about 370 nm or not greater than about 360 nm or not greater than about 350 nm or not greater than about 340 nm or not greater than about 330 nm or not greater than about 320 nm or not greater than about 310 nm or not greater than about 300 nm.

Embodiment 30. The composite film of any one of the previous embodiments, wherein the composite film further comprises a second anti-reflective coating overlying a second surface of the first transparent substrate, wherein the second surface of the first transparent substrate is parallel to and opposite of the first surface of the first transparent substrate.

Embodiment 31. The composite film of embodiment 30, wherein the second anti-reflective coating comprises a second binder component and a second particulate filler component, wherein the particulate filler component comprises hollow silica nanoparticles.

Embodiment 32. The composite film of embodiment 31, wherein the composite film comprises the second binder component at a concentration of at least about 30.0 wt. % for a total weight of the second anti-reflective coating.

Embodiment 33. The composite film of embodiment 31, wherein the composite film comprises the second binder component at a concentration of not greater than about 60.0 wt. % for a total weight of the second anti-reflective coating.

Embodiment 34. The composite film of embodiment 31, wherein the second binder component comprises a UV curable binder.

Embodiment 35. The composite film of embodiment 34, wherein the UV curable binder comprises a UV curable acrylate, such as urethane acrylate, epoxy acrylate, polyester acrylate.

Embodiment 36. The composite film of embodiment 31, wherein the second binder component comprises a curable polymeric binder.

Embodiment 37. The composite film of embodiment 36, wherein the curable polymeric binder comprises an acrylic binder, a polyester binder, epoxy binder.

Embodiment 38. The composite film of embodiment 31, wherein the composite film comprises the second particulate filler component at a concentration of at least about 40.0 wt. % for a total weight of the second anti-reflective coating.

Embodiment 39. The composite film of embodiment 31, wherein the composite film comprises the second particulate filler component at a concentration of not greater than about wt. % for a total weight of the second anti-reflective coating.

Embodiment 40. The composite film of embodiment 31, wherein the composite film comprises the hollow silica nanoparticles at a concentration of at least about 40.0 wt. % for a total weight of the second anti-reflective coating.

Embodiment 41. The composite film of embodiment 31, wherein the composite film comprises a hollow silica nanoparticles at a concentration of not greater than about 70.0 wt. % for a total weight of the second anti-reflective coating.

Embodiment 42. The composite film of embodiment 31, wherein the second particulate filler component has an average particle size of at least about 120 nm.

Embodiment 43. The composite film of embodiment 31, wherein the second particulate filler component has an average particle size of not greater than about 200 nm.

Embodiment 44. The composite film of embodiment 31, wherein the hollow silica nanoparticles has an average particle size of at least about 120 nm.

Embodiment 45. The composite film of embodiment 31, wherein the hollow silica nanoparticles has an average particle size of not greater than about 200 nm.

Embodiment 46. The composite film of embodiment 31, wherein the hollow silica nanoparticles are spherical nanoparticles.

Embodiment 47. The composite film of embodiment 31, wherein the composite film further comprises a second anti-smudge additive.

Embodiment 48. The composite film of embodiment 47, wherein the composite film comprises the second anti-smudge additive a concentration of at least about 0.3 wt. % for a total weight of the second anti-reflective coating.

Embodiment 49. The composite film of embodiment 47, wherein the composite film comprises the second anti-smudge additive a concentration of not greater than about 5.0 wt. % for a total weight of the second anti-reflective coating.

Embodiment 50. The composite film of embodiment 47, wherein the second anti-smudge additive comprises a silicone acrylate, a fluoro acrylate, fluorinated poly(meth)acrylate.

Embodiment 51. The composite film of any one of the previous embodiments, wherein the second anti-reflective coating has a thickness of at least about 50 nm or at least about 60 nm or at least about 70 nm or at least about 80 nm or at least about 90 nm or at least about 100 nm or at least about 110 nm or at least about 120 nm or at least about 130 nm or at least about 140 nm or at least about 150 nm or at least about 160 nm or at least about 170 nm or at least about 180 nm or at least about 190 nm or at least about 200 nm.

Embodiment 52. The composite film of any one of the previous embodiments, wherein the second anti-reflective coating has a thickness of not greater than about 500 nm or not greater than about 490 nm or not greater than about 480 nm or not greater than about 470 nm or not greater than about 460 nm or not greater than about 450 nm or not greater than about 440 nm or not greater than about 430 nm or not greater than about 420 nm or not greater than about 410 nm or not greater than about 400 nm or not greater than about 390 nm or not greater than about 380 nm or not greater than about 370 nm or not greater than about 360 nm or not greater than about 350 nm or not greater than about 340 nm or not greater than about 330 nm or not greater than about 320 nm or not greater than about 310 nm or not greater than about 300 nm.

Embodiment 53. The composite film of any one of the previous embodiments, wherein the first transparent substrate comprises a PET film.

Embodiment 54. The composite film of any one of the previous embodiments, wherein the first transparent substrate comprises an optically clear PET film.

Embodiment 55. The composite film of any one of the previous embodiments, wherein the first transparent substrate comprises a single layer optically clear PET film.

Embodiment 56. The composite film of any one of the embodiments 53, 54, and 55, wherein PET film comprises a thickness of at least about 5 mil or at least about 6 mil or at least about 7 mil or at least about 8 mil or at least about 9 mil or at least about 10 mil.

Embodiment 57. The composite film of any one of the embodiments 53, 54, and 55, wherein PET film comprises a thickness of not greater than about 15 mil or not greater than about 14 mil or not greater than about 13 mil or not greater than about 12 mil or not greater than about 11 mil.

Embodiment 58. The composite film of any one of the previous embodiments, wherein the first transparent substrate comprises at least a first PET film and a second PET film.

Embodiment 59. The composite film of embodiment 58, wherein the first transparent substrate comprises a first laminating adhesive between the first PET film and the second PET film.

Embodiment 60. The composite film of embodiment 42, wherein the first laminating adhesive comprises a pressure sensitive adhesive (PSA) or a polyester adhesive cured with a polyisocyanate curing agent.

Embodiment 61. The composite film of embodiment 60, wherein the pressure sensitive adhesive comprises an acrylic pressure sensitive adhesive.

Embodiment 62. The composite film of embodiment 58, wherein the first PET film comprises an optically clear PET film.

Embodiment 63. The composite film of embodiment 58, wherein the second PET film comprises an optically clear PET film.

Embodiment 64. The composite film of any one of the embodiments 58, 59, 62, and 63, wherein the first PET film comprises a thickness of at least about 5 mil or at least about 6 mil or at least about 7 mil or at least about 8 mil or at least about 9 mil or at least about 10 mil.

Embodiment 65. The composite film of any one of the embodiments 58, 59, 62, and 63, wherein second PET film comprises a thickness of not greater than about 15 mil or not greater than about 14 mil or not greater than about 13 mil or not greater than about 12 mil or not greater than about 11 mil.

Embodiment 66. The composite film of any one of the previous embodiments, wherein the first transparent substrate comprises a thickness of at least about 1 mil or at least about 2 mil or at least about 3 mil or at least about 4 mil or at least about 5 mil or at least about 6 mil or at least about 7 mil or at least about 8 mil or at least about 9 mil or at least about 10 mil.

Embodiment 67. The composite film of any one of the previous embodiments, wherein the first transparent substrate comprises a thickness of not greater than about 20 mil or not greater than about 19 mil or not greater than about 18 mil or not greater than about 17 mil or not greater than about 16 mil or not greater than about 15 mil or not greater than about 14 mil or not greater than about 13 mil or not greater than about 12 mil or not greater than about 11 mil.

Embodiment 68. The composite film of any one of the previous embodiments, wherein the composite film further comprises a protective liner overlying the first anti-reflective coating; and wherein the first anti-reflective coating is between the first transparent substrate and the protective liner.

Embodiment 69. The composite film of embodiment 68, wherein the protective liner is a colored liner.

Embodiment 70. The composite film of embodiment 68, wherein the protective liner comprises a low tack adhesive.

Embodiment 71. The composite film of any one of the previous embodiments, wherein the composite film is configured to overly a medical hood.

Embodiment 72. The composite film of any one of the previous embodiments, wherein the composite film is configured to overly an optical lens, wherein the optical lens is a portion of a pair of googles.

Embodiment 73. The composite film of any one of the previous embodiments, wherein the composite film is configured to overly a face shield, wherein the face shield is associated with racing optics.

Embodiment 74. A method of forming a composite film, wherein the method comprises: providing a first anti-reflective coating formulation comprising an active coating mixture comprising a first binder component and a first particulate filler component; applying the anti-reflective coating formulation to a first transparent substrate; and drying the anti-reflective coating formulation to form a first anti-reflective coating overlying the first transparent substrate.

Embodiment 75. The method of embodiment 74, wherein providing the first anti-reflective coating formulation further comprises dissolving the active coating mixture in an organic solvent mixture.

Embodiment 76. The method of embodiment 75, wherein the organic solvent mixture comprises methyl ethyl ketone (MEK), methyl isobutyl ketone (MIBK) or a combination thereof.

Embodiment 77. The method of embodiment 76, wherein the organic solvent mixture further comprises propylene glycol monomethyl ether acetate (PGMEA).

Embodiment 78. The method of embodiment 77, wherein the organic solvent mixture further comprises a wetting agent, a flow agent, a de-foaming agent or combinations thereof.

Embodiment 79. The method of embodiment 75, wherein the anti-reflective coating formulation comprises the active coating mixture at a concentration of at least about 1 vol. % for a total volume of the anti-reflective coating formulation or at least about 1.3 vol. % or at least about 1.5 vol. % or at least about 1.8 vol. % or at least about 2.0 vol. % or at least about 2.3 vol. % or at least about 2.5 vol. % or at least about 2.8 vol. % or at least about 3.0 vol. % or at least about 3.3 vol. % or at least about 3.5 vol. % or at least about 3.8 vol. % or at least about 4.0 vol. % or at least about 4.3 vol. % or at least about 4.5 vol. %.

Embodiment 80. The method of embodiment 79, wherein the anti-reflective coating formulation comprises the active coating mixture at a concentration of not greater than about 10 vol. % for a total volume of the anti-reflective coating formulation or not greater than about 9.8 vol. % or not greater than about 9.5 vol. % or not greater than about 9.3 vol. % or not greater than about 9.0 vol. % or not greater than about 8.8 vol. % or not greater than about 8.5 vol. % or not greater than about 8.3 vol. % or not greater than about 8.0 vol. % or not greater than about 7.8 vol. % or not greater than about 7.5 vol. % or not greater than about 7.3 vol. % or not greater than about 7.0 vol. % or not greater than about 6.8 vol. % or not greater than about 6.5 vol. % or not greater than about 6.3 vol. % or not greater than about 6.0 vol. % or not greater than about 5.8 vol. % or not greater than about 5.5 vol. %.

Embodiment 81. The method of embodiment 75, wherein the anti-reflective coating formulation comprises the organic solvent mixture at a concentration of at least about 90.0 vol. % for a total volume of the anti-reflective coating formulation or at least about 90.5 vol. % or at least about 91.0 vol. % or at least about 91.5 vol. % or at least about 92.0 vol. % or at least about 92.5 vol. % or at least about 93.0 vol. % or at least about 93.5 vol. % or at least about 94.0 vol. % or at least about 94.5 vol. %.

Embodiment 82. The method of embodiment 79, wherein the anti-reflective coating formulation comprises the organic solvent mixture at a concentration of not greater than about 99.0 vol. % for a total volume of the anti-reflective coating formulation or not greater than about 98.5 vol. % or not greater than about 98.0 vol. % or not greater than about 97.5 vol. % or not greater than about 96.0 vol. % or not greater than about 95.5 vol. %.

Embodiment 83. The method of embodiment 75, wherein the anti-reflective coating formulation comprises the first binder component at a concentration of at least about 0.50 vol. % for a total volume of the anti-reflective coating formulation.

Embodiment 84. The method of embodiment 75, wherein the anti-reflective coating formulation comprises the first binder component at a concentration of not greater than about 1.2 vol. % for a total volume of the anti-reflective coating formulation.

Embodiment 85. The method of embodiment 75, wherein the anti-reflective coating formulation comprises the first particulate filler component at a concentration of at least about 0.30 vol. % for a total volume of the anti-reflective coating formulation.

Embodiment 86. The method of embodiment 75, wherein the anti-reflective coating formulation comprises the first particulate filler component at a concentration of not greater than about 1.2 vol. % for a total volume of the anti-reflective coating formulation.

Embodiment 87. The method of embodiment 74, wherein applying the anti-reflective coating formulation to form the first anti-reflective coating comprises applying the coating using a Meyer rod, a gravure, dip coating, slot die and other coating methods Embodiment 88. The method of embodiment 74, wherein drying the anti-reflective coating formulation comprises drying the coating in an oven and then curing the coating using a UV light, e-beam or other high-energy rays.

### EXAMPLES

The concepts described herein will be further described in the following Examples, which do not limit the scope of the invention described in the claims.

### Example 1

Nine sample composite films S1-S9 were formed according to embodiments described herein.

The first sample composite film S1 was formed according to embodiments described herein by preparing a slurry of hollow nano silica (LDS-100) and UV binder PETIA (PETIA is a mixture of predominantly the tri- and tetra-acrylate esters of pentaerythritol). The hollow nano silica (LDS-100) and UV binder PETIA were dispersed in MIBK (methyl isobutyl ketone) solvent along with certain amount photo initiator. The ratio of hollow nano silica to PETIA was around 55 to 45. The slurry was made to 2% total solid as hollow silica UV-cure paste. 28.5 grams of the hollow silica UV-cure paste was mixed with 1.5 grams of PGMEA (Propyl glycol methyl ether acetate) as a coating slurry. The coating slurry was coated with #3 rod onto an 8 mil PET film, dried in an oven at 110° C. for 10 second (to remove the solvents) and then cured under UV light to a first AR layer on the substrate. This same coating was applied to the other side of 1 St AR coating to form an AR film with AR coating on both sides of the PET substrate.

The second sample composite film S2 was formed according to embodiments described herein by preparing an anti-reflective coating in the same manner as the first sample composite film S1. The coating was coated with a #3 rod on one side of a 7 mil PET film, and then an acrylic pressure sensitive adhesive coating at around 4.0 lb/ream (or 6.4 grams/m²) was coated on the opposite of the ant-reflective coating side of the PET film. The adhesive side was laminated to 3 mm thick glass plate.

The third sample composite film S3 was formed according to embodiments described herein by preparing a slurry of hollow nano silica (LDS-100) and UV binder PETIA. The hollow nano silica (LDS-100) and UV binder PETIA were dispersed in MIBK solvent along with certain amount photo initiator. The ratio of hollow nano silica to PETIA is around 55 to 45. The slurry was made to 2% total solid as hollow silica UV-cure paste. 28.5 grams of the hollow silica UV-cure paste was mixed with 1.5 grams of PGMEA as a coating slurry. The coating slurry was coated with #3 rod onto an 8 mil PET film, dried in an oven at 110° C. for 10 second (to remove the solvents) and then cured under UV light to a first AR layer on the substrate. This same coating is applied to the other side of 1 St AR coating to form an AR film with AR coating on both sides of the PET substrate. A top coat solution was made of 9.925 grams of IPA (Isopropyl alcohol), 0.012 grams of Fluorolink S10, 0.012 grams of Cyracure 6976, 0.012 grams of acetic acid and 0.039 grams of distilled water. This top coat solution was applied with #5 rod onto the anti-reflective coating, dried and then UV cured for achieving high water contact angle surface.

The fourth sample composite film S4 was formed according to embodiments described herein by preparing a slurry of hollow nano silica (LDS-100) and UV binder PETIA. The hollow nano silica (LDS-100) and UV binder PETIA were dispersed in MIBK solvent along with certain amount photo initiator. The ratio of hollow nano silica to PETIA is around 55 to 45. The slurry was made to 2% total solid as hollow silica UV-cure paste. 28.20 grams of the hollow silica UV-cure paste was mixed with 1.74 grams of PGMEA and 0.06 grams of Ebecryl 8110 as a coating slurry. The coating slurry was with #3 rod onto an 8 mil PET film, dried in an oven at 110° C. for 10 second (to remove the solvents) and then cured under UV light to a first anti-reflective layer on the substrate. This same coating is applied to the other side of 1 St anti-reflective coating to form an anti-reflective film with anti-reflective coating on both sides of the PET.

The fifth sample composite film S5 was formed according to embodiments described herein by preparing a slurry of hollow nano silica (LDS-100) and UV binder PETIA. The hollow nano silica (LDS-100) and UV binder PETIA were dispersed in MIBK solvent along with certain amount photo initiator. The ratio of hollow nano silica to PETIA is around 55 to 45. The slurry was made to 2% total solid as hollow silica UV-cure paste. 26.70 grams of the hollow silica UV-cure paste was mixed with 3.21 grams of PGMEA and 0.09 grams of Ebecryl 8110 as a coating slurry. The coating slurry was with #3 rod onto an 8 mil PET film, dried in an oven at 110° C. for 10 second (to remove the solvents) and then cured under UV light to a first anti-reflective layer on the substrate. This same coating is applied to the other side of 1 St anti-reflective coating to form an anti-reflective film with anti-reflective coating on both sides of the PET substrate.

The sixth sample composite film S6 was formed according to embodiments described herein by preparing a slurry of hollow nano silica (LDS-100) and UV binder PETIA. The hollow nano silica (LDS-100) and UV binder PETIA were dispersed in MIBK solvent along with certain amount photo initiator. The ratio of hollow nano silica to PETIA is around 55 to 45. The slurry was made to 2% total solid as hollow silica UV-cure paste. 29.36 grams of the hollow silica UV-cure paste was mixed with 0.60 grams of PGMEA, 0.02 grams of Tegorad 2500 solution (10% Tegorad 2500 and 90% PGMEA) and 0.02 grams of Tegorad 2100 solution (10% Tegorad 2100 and 90% PGMEA) as a coating slurry. The coating slurry was with #3 rod onto an 8 mil PET film, dried in an oven at 110° C. for 10 second (to remove the solvents) and then cured under UV light to a first AR layer on the substrate. This same coating is applied to the other side of 1 St anti-reflective coating to form an anti-reflective film with anti-reflective coating on both sides of the PET substrate.

The seventh composite sample S7 was formed according to embodiments described herein by preparing a slurry of hollow nano silica (LDS-100) and UV binder PETIA. The hollow nano silica (LDS-100) and UV binder PETIA were dispersed in MIBK solvent along with certain amount photo initiator. The ratio of hollow nano silica to PETIA is around 55 to 45. The slurry was made to 2% total solid as hollow silica UV-cure paste. 29.36 grams of the hollow silica UV-cure paste was mixed with 0.60 grams of PGMEA, 0.02 grams of Tegorad 2500 solution (10% Tegorad 2500 and 90% PGMEA) and 0.02 grams of Tegorad 2100 solution (10% Tegorad 2100 and 90% PGMEA) as a coating slurry. The coating slurry was with #3 rod onto an 8 mil PET film, dried in an oven at 110° C. for 10 second (to remove the solvents) and then cured under UV light to a first AR layer on the substrate. This same coating is applied to the other side of 1 St AR coating to form an anti-reflective film with anti-reflective coating on both sides of the PET substrate. A top coat solution was made of 9.925 grams of IPA, 0.012 grams of Flurolink S10, 0.012 grams of Cyracure 6976, 0.012 grams of acetic acid and 0.039 grams of distilled water. This top coat solution was applied with #5 rod onto the anti-reflective coating, dried and then UV cured for achieving high water contact angle surface.

The eighth composite sample S8 was formed according to embodiments described herein by preparing a slurry of hollow nano silica (LDS-100) and UV binder PETIA. The hollow nano silica (LDS-100) and UV binder PETIA were dispersed in MIBK solvent along with certain amount photo initiator. The ratio of hollow nano silica to PETIA is around 55 to 45. The slurry was made to 2% total solid as hollow silica UV-cure paste. 19.58 grams of the hollow silica UV-cure paste was mixed with 0.26 grams of PGMEA, 0.08 grams of Tegorad 2500 solution (10% Tegorad 2500 and 90% PGMEA) and 0.08 grams of Tegorad 2100 solution (10% Tegorad 2100 and 90% PGMEA) as a coating slurry. The coating slurry was with #3 rod onto an 8 mil PET film, dried in an oven at 110° C. for 10 second (to remove the solvents) and then cured under UV light to a first anti-reflective layer on the substrate. This same coating is applied to the other side of 1^{st} anti-reflective coating to form an anti-reflective film with anti-reflective coating on both sides of the PET substrate.

The second sample composite film S9 was formed according to embodiments described herein by preparing an anti-reflective coating in the same manner as Example 8 on one side of 7 mil PET film, and then an acrylic pressure sensitive adhesive coating at around 4.0 lb/ream (or 6.4 grams/m²) was coated on the opposite of the anti-reflective coating of the PET film. The adhesive side was laminated to 3 mm glass plate.

Each of the sample composite film S1-S9 were tested for VLT and water contact angle. The results of the tests are summarized in table 1 below:

TABLE 1
Performance Results for Sample Composite Film S1-S9

| Sample | VLT | WCA |
|---|---|---|
| S1 | 98.5 | 74.1 |
| S2 | 93.9 | 75.2 |
| S3 | 98.5 | 105.7 |
| S4 | 98.8 | 94.9 |
| S5 | 98.7 | 98.0 |
| S6 | 98.4 | 83.6 |
| S7 | 98.4 | 103.9 |
| S8 | 99.0 | 101.6 |
| S9 | 93.9 | 92.4 |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1-15. (canceled)

16. A composite film comprising:
a first transparent substrate; and
a first anti-reflective coating overlying a first surface of the first transparent substrate,
wherein the first anti-reflective coating comprises a first binder component and a first particulate filler component,
wherein the first particulate filler component comprises hollow silica nanoparticles,
wherein the composite film has a VLT of at least about 94.0%, and
wherein the composite film has a water contact angle of at least about 70°.

17. The composite film of claim 16, wherein the composite film further comprises a VLT of at least about 94.0% and not greater than about 99.9%.

18. The composite film of claim 16, wherein the composite film further comprises a haze of at least about 0.5% and not greater than about 2.0%.

19. The composite film of claim 16, wherein the composite film further comprises a reflectance of at least about 1.5% and not greater than about 7.0% as measured at 550 nm.

20. The composite film of claim 16, wherein the composite film comprises the first binder component at a concentration of at least about 30.0 wt. % and not greater than about wt. % for a total weight of the first anti-reflective coating.

21. The composite film of claim 16, wherein the first binder component comprises a UV curable binder.

22. The composite film of claim 16, wherein the composite film comprises the first particulate filler component at a concentration of at least about 40.0 wt. % and not greater than about 70.0 wt. % for a total weight of the first anti-reflective coating.

23. The composite film of claim 16, wherein the composite film comprises the hollow silica nanoparticles at a concentration of at least about 40.0 wt. % and not greater than about 70.0 wt. % for a total weight of the first anti-reflective coating.

24. The composite film of claim 16, wherein the first particulate filler component has an average particle size of at least about 120 nm and not greater than about 200 nm.

25. The composite film of claim 16, wherein the hollow silica nanoparticles has an average particle size of at least about 120 nm and not greater than about 200 nm.

26. The composite film of claim 16, wherein the hollow silica nanoparticles are spherical nanoparticles.

27. The composite film of claim 16, wherein the composite film further comprises a first anti-smudge additive.

28. The composite film of claim 16, wherein the first anti-reflective coating has a thickness of at least about 50 nm and not greater than about 500 nm.

29. A composite film comprising:
a first transparent substrate; and
a first anti-reflective coating overlying a first surface of the first transparent substrate,
wherein the first anti-reflective coating comprises a first binder component and a first particulate filler component,
wherein the first particulate filler component comprises hollow silica nanoparticles,
wherein the composite film has a VLT of at least about 94.0%, and
wherein the composite film has a water contact angle of at least about 80°.

30. The composite film of claim 29, wherein the composite film further comprises a VLT of at least about 94.0% and not greater than about 99.9%.

31. The composite film of claim 29, wherein the composite film further comprises a haze of at least about 0.5% and not greater than about 2.0%.

32. The composite film of claim 29, wherein the composite film further comprises a reflectance of at least about 1.5% and not greater than about 7.0% as measured at 550 nm.

33. The composite film of claim 29, wherein the composite film comprises the first binder component at a concentration of at least about 30.0 wt. % and not greater than about wt. % for a total weight of the first anti-reflective coating.

34. The composite film of claim 29, wherein the first binder component comprises a UV curable binder.

35. A method of forming a composite film, wherein the method comprises:
providing a first anti-reflective coating formulation comprising an active coating mixture comprising a first binder component and a first particulate filler component;
applying the anti-reflective coating formulation to a first transparent substrate; and
drying the anti-reflective coating formulation to form a first anti-reflective coating overlying the first transparent substrate.
